(19) United States
(12) Patent Application Publication
(10) Pub. No.: US 2026/0086048 A1
(43) Pub. Date: Mar. 26, 2026

(54) SYSTEMS AND METHODS FOR IMPROVING PRECISION OF ROBOT BASED LAMINOGRAPHY

(71) Applicant: Baker Hughes Holdings LLC, Houston, TX (US)

(72) Inventor: Michael Wuestenbecker, Ahrensbury (DE)

(21) Appl. No.: 19/314,440

(22) Filed: Aug. 29, 2025

Related U.S. Application Data
(60) Provisional application No. 63/698,273, filed on Sep. 24, 2024.

(51) Int. Cl. G01N 23/044; G01N 23/083

(52) U.S. Cl. CPC G01N 23/044; G01N 23/083; G01N 2223/308; G01N 2223/3303

(57) ABSTRACT

Systems and methods for improving precision of robot based laminography are provided that include a first robotic arm controllable to move an x-ray tube to a first pre-scanning position proximate a region of interest (ROI) of an asset, a first precision end effector provided between the first robotic arm and the x-ray tube and controllable to move the x-ray tube along a first precise scanning path during an inspection while the first robotic arm remains fixed in the first pre-scanning position, a second robotic arm controllable to move an x-ray detector to a second pre-scanning position proximate the ROI and opposite the x-ray tube, and a second precision end effector provided between the second robotic arm and the x-ray detector and controllable to move the x-ray detector along a second precise scanning path during the inspection while the second robotic arm remains fixed in the second pre-scanning position.

### CROSS-REFERENCE TO RELATED APPLICATIONS

This application claims priority under 35 U.S.C. § 119(e) to U.S. Provisional Application No. 63/698,273, filed Sep. 24, 2024, and entitled “SYSTEMS AND METHODS FOR IMPROVING PRECISION OF ROBOT BASED LAMINOGRAPHY,” the contents of which are hereby incorporated by reference in their entirety.

### FIELD

The subject matter described herein relate to systems and methods of high precision robotic laminography, particularly for use in the inspection of large objects.

### BACKGROUND

Robotic laminography is an x-ray imaging technique that can be used for Non-Destructive Testing (NDT) of objects. Laminography, like computed tomography (CT), functions by placing an x-ray tube and an x-ray detector on opposing sides of an object being scanned, and transmitting x-rays through the object, from the tube to the detector. In CT imaging, the object being imaged is either placed on a rotating stage that rotates the object through 360 degrees, taking images at each angle, or by keeping the object stationary and rotating the x-ray tube and an x-ray detector around the object through 360 degrees, taking images at each angle (i.e., a conventional medical CT scanner). Alternatively, conventional robotic laminography systems operate by positioning the x-ray tube on one side of the object and the x-ray detector on the other side of the object and acquiring images at only a limited number of angles, rather than 360 degrees around the object, which can be used to produce three-dimensional internal and external representations of the object.

### SUMMARY

In one aspect, a precision movement device is provided that includes a first mounting surface operable to mount the precision movement device to a robotic manipulation unit; a second mounting surface operable to mount to an x-ray tube or an x-ray detector to the precision movement device; and one or more motors provided between the first mounting surface and the second mounting surface, wherein the one or more motors are arranged to translate the second mounting surface relative to the first mounting surface along first and second precision axes parallel to the second mounting surface while a position of the first mounting surface is be fixed.

In some aspects, the one or more motors are arranged to translate the second mounting surface along the first and second precision axes with a precision of less than 20 microns.

In some aspects, the precision movement device may further include the robotic manipulation unit, wherein the robotic manipulation unit is a robotic arm that includes a plurality of motorized joints arranged to control translational and rotational movement of the precision movement device variously along and about a plurality of pre-positioning axes to a pre-scanning position near an asset prior to performing an inspection of the asset.

In some aspects, the one or more motors may be arranged to translate the x-ray tube or x-ray detector variously along the first and second precision axes along a precise scanning path during the inspection when the robotic manipulation unit can be fixed in the pre-scanning position.

In some aspects, the precision movement device may further include a position sensor operatively coupled to the precision movement device and arranged to measure a position and a tilt angle of the x-ray tube or x-ray detector.

In some aspects, the precision movement device may further include a controller arranged to control movement of the precision movement device and the robotic arm, wherein the controller is arranged to perform operations including receiving position data characterizing the position and tilt angle of the x-ray tube or x-ray detector from the position sensor; controlling the robotic arm to place the precision movement device in the pre-scanning position; and controlling the one or more motors of the precision movement device to translate the x-ray tube or x-ray detector along the precise scanning path during the inspection.

In some aspects, the robotic arm may be mounted to any of a ground, a wall, or a ceiling of an x-ray shielding room.

In another aspect, a method for improving precision of robot based laminography is provided that includes: controlling a first robotic arm to place an x-ray tube in a first pre-scanning position proximate a region of interest (ROI) of an asset to be inspected, wherein the x-ray tube is coupled to the first robotic arm by a first precise movement device; controlling a second robotic arm to place an x-ray detector in a second pre-scanning position opposite the first pre-scanning position such that the ROI is between the x-ray tube and the x-ray detector, wherein the x-ray detector is coupled to the second robotic arm by a second precise movement device; controlling the first precision movement device to move the x-ray tube along a first precise path proximate the ROI while emitting x-rays through the asset and while the first robotic arm remains fixed in the first pre-scanning position; and controlling the second precision movement device to move the x-ray detector along a second precise path proximate the ROI while receiving the x-rays emitted through the asset by the x-ray tube and while the second robotic arm remains fixed in the second pre-scanning position.

In some aspects, the first and second precision movement devices may be arranged to move the x-ray tube and detector along the first and second precise paths, respectively, with a precision of less than 20 microns.

In some aspects, the first pre-scanning position can be a first distance from a surface of the asset than the second pre-scanning position can be a second distance from the surface of the asset, and movement of the x-ray tube and detector along the first and second precise paths, respectively, may be proportionate to the first and second distances.

In some aspects, the first distance may be less than the second distance and movement of the x-ray tube along the first precise path can be less than movement of the x-ray detector along the second precise path.

In some aspects, the method may further include controlling the x-ray tube to emit x-rays through the asset at a plurality of angles as the x-ray tube is moved along the first precise path; acquiring a plurality of x-ray images of the ROI from the x-ray detector; and generating a comprehensive view of the ROI based on the plurality of x-ray images.

In some aspects, the method may further include controlling the first robotic arm to move the x-ray tube to a third pre-scanning position proximate a next ROI of the asset; controlling the second robotic arm to move the x-ray detector to a fourth pre-scanning position opposite the third pre-scanning position such that the next ROI can be between the x-ray tube and the x-ray detector; controlling the first precision movement device to move the x-ray tube along a third precise path proximate the ROI while emitting x-rays through the asset and while the first robotic arm may remain fixed in the third pre-scanning position; controlling the second precision movement device to move the x-ray detector along a fourth precise path proximate the ROI while receiving the x-rays emitted through the asset by the x-ray tube and while the second robotic arm may remain fixed in the fourth pre-scanning position; acquiring a next plurality of x-ray images of the next ROI from the x-ray detector; and generating a comprehensive view of the asset by combining the comprehensive view of the ROI and a comprehensive view of the next ROI.

In some aspects, the first and second precise paths may be non-linear two-dimensional scanning paths.

In another aspect, a system is provided that includes a first robotic arm controllable to move an x-ray tube to a first pre-scanning position proximate a region of interest (ROI) of an asset to be inspected; a first precision end effector provided between the first robotic arm and the x-ray tube and controllable to move the x-ray tube along a first precise scanning path proximate the ROI during an inspection while the first robotic arm may remain fixed in the first pre-scanning position; a second robotic arm controllable to move an x-ray detector to a second pre-scanning position proximate the ROI and opposite the x-ray tube; and a second precision end effector provided between the second robotic arm and the x-ray detector and controllable to move the x-ray detector along a second precise scanning path proximate the ROI during the inspection while the second robotic arm may remain fixed in the second pre-scanning position.

In some aspects, the first and second precision end effectors may be arranged to move the x-ray tube and the x-ray detector relative to the first and second robotic arms, respectively, with a precision of less than 20 microns.

In some aspects, the first and second robotic arms may be mounted to any of a ground, a wall, or a ceiling of an x-ray shielding room.

In some aspects, the system may further include a controller arranged to control the first precision end effector to translate the x-ray tube along the first precise scanning path and the second precision end effector to translate the x-ray detector along the second precise scanning path to perform an inspection of the ROI.

In some aspects, the first precision end effector may include a first position sensor arranged to measure a position and a tilt angle of the x-ray tube and the second precision end effector may include a second position sensor arranged to measure a position and a tilt angle of the x-ray detector.

In some aspects, the controller may be further arranged to receive, from the first and second position sensors, position data characterizing the position and tilt angle of the x-ray tube in the first pre-scanning position and the x-ray detector in the second pre-scanning position; and control the first and second precision end effectors to translate the x-ray tube and x-ray detector along the first and second precise scanning paths, respectively, responsive to determining that the x-ray tube in the first pre-scanning position can be properly aligned with the x-ray detector in the second pre-scanning position.

### DESCRIPTION OF DRAWINGS

These and other features will be more readily understood from the following detailed description taken in conjunction with the accompanying drawings, in which:

FIG. 1 is a rendering of an exemplary robotic laminography system according to the subject matter described herein;

FIG. 2 is a rendering of an exemplary robotic arm system according to the subject matter described herein;

FIG. 3 is a rendering of another exemplary robotic arm system according to the subject matter described herein;

FIGS. 4A-4B are front and top views, respectively, of an exemplary precision movement assembly according to the subject matter described herein;

FIGS. 4C-4D are front and top views, respectively, of another exemplary precision movement assembly according to the subject matter described herein;

FIGS. 5A-5B illustrate two top views, respectively, of another exemplary robotic laminography system according to the subject matter described herein, captured at two distinct instances during an inspection operation; and

FIG. 6 is a block diagram of a computing system suitable for use in implementing the computerized components described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

As described above, conventional laminography systems operate by positioning the x-ray tube on one side of the object and the x-ray detector on the other side of the object and acquiring images at only a limited number of angles, rather than 360 degrees around the object. However, in cases where the object being imaged is large, for example, large batteries for electrical vehicles or large hydrogen tanks, which can span multiple meters, conventional laminography systems are ill-equipped to acquire precise images of the entire object. Specifically, when imaging large objects, the x-ray tube and detector must acquire multiple scans at disparate locations across the object. Conventionally, this has been achieved by coupling the x-ray tube and detector to robotic arms that can move along up to six axes, to move the tube and detector about the object and acquire scans. However, while these robotic arms are sufficient to move the tube and detector globally around the object, they have limited precision in their movements, which leads to poor image quality during scanning of the object. To address these problems, solutions have been provided that include large, granite-based manipulators that are capable of moving with greater precision that robotic arms. However, these large, granite-based manipulators significantly heavy (e.g., on the order of 15 tons or more) an are inflexible to adapt to customer needs.

The systems and methods described herein address the aforementioned shortcoming by providing robotic laminography systems that are capable of moving x-ray tubes and detectors across large distances to multiple pre-scanning positions on large objects, while also being capable of translating the x-ray tubes and detectors along high precision axes during scanning operations. In some aspects, the systems and methods described herein can include a pair of robotic arms that are capable of moving along one or more pre-positioning axes, where each robotic arm includes a precision movement device (also referred to herein as a precision end effector) provided at a distal end of the arm. The precision movement devices can include a first mounting surface operable to mount to the distal end of the robotic arm and a second mounting surface operable to mount to an x-ray tube or an x-ray detector. The precision movement devices also include one or more motors provided between the first mounting surface and the second mounting surface that are arranged to translate the second mounting surface along one or more precision axes relative to the first mounting surface while a position of the first mounting surface is fixed.

By providing a robotic laminography system includes robotic arms that are capable of moving x-ray tubes and detectors across large distances to multiple pre-scanning positions on large objects and then fixing the positions of the arms while translating the x-ray tubes and detectors variously along precision axes during scanning, the system can capture high quality scans of the entire object, without having to move the object during inspection. The systems and methods described herein are particularly advantageous for NDT of large objects, as they allow for high flexibility, by leveraging low-cost standard industrial robots that are capable of moving across large distances and modifying them to include the high-precision movement devices described herein to allow for precise movements of the x-ray tubes and detectors during scanning. Additionally, by leveraging these improved robotic arm assemblies, the systems and methods described herein are significantly smaller than the large, granite-based manipulators described above. This advantageously allows for the overall dimensions of the x-ray shielding rooms—that are needed to house the robotic laminography systems and the objects being inspected—to be reduced.

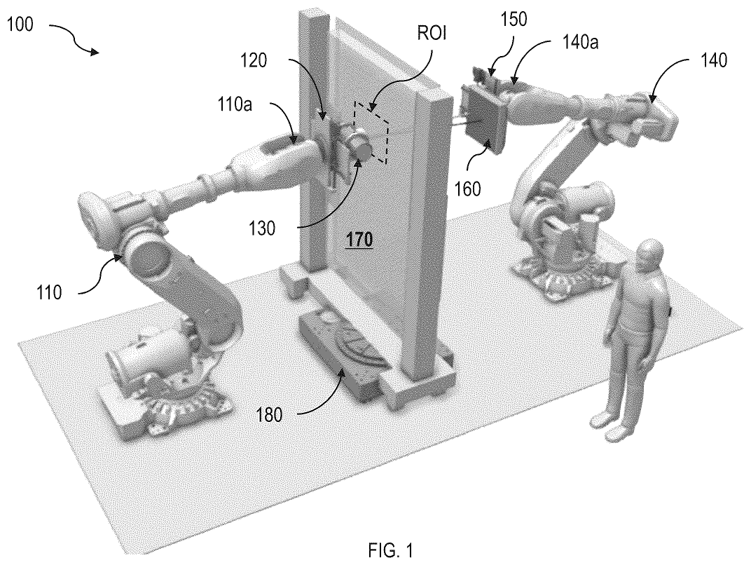

FIG. 1 is a rendering of an exemplary robotic laminography system 100 according to the subject matter described herein. The system 100 can include a first robotic arm 110 having a first precision movement device/end effector 120 coupled to a distal end 110a of the robotic arm 110. The system 100 can also include an x-ray tube 130 that is operatively coupled to the first precision movement device 120, as described in greater detail below. Similarly, the system 100 can include a second robotic arm 140 having a second precision movement device/end effector 150 coupled to a distal end 140a of the robotic arm 140. The system 100 can also include an x-ray detector 160 that is operatively coupled to the second precision movement device 140, as described in greater detail below. In some aspects, an asset 170 can be positioned in between the first and second robotic arms 110, 140, as shown in FIG. 1. For example, in some cases, the asset 170 can be a large battery that requires laminographic inspection, for example, for quality control in manufacturing, for routine maintenance/defect detection, or for a number of other reasons. In some aspects, the asset can additionally be coupled to a turntable 180 arranged to rotate the asset 170, however, a turntable is not required.

The first and second robotic arms 110, 140 can each include a plurality of motorized joints that can allow for the arms to move in a plurality of directions, as described in greater detail below. Accordingly, to perform an inspection of the asset 170, the first and second robotic arms 110, 140 can be arranged to move the x-ray tube 130 and the x-ray detector 160, respectively, to a pre-scanning position near the surface of the asset 170, via variable actuations of their motorized joints. The pre-scanning positions of the x-ray tube 130 and the x-ray detector 160 can be determined based on a number of factors, as discussed in greater detail below. For example, as shown in FIG. 1, it may be advantageous for a pre-scanning position of the x-ray tube 130 to be closer to the surface of the asset 170 than a pre-scanning position of the x-ray detector 160.

Once the first and second robotic arms 110, 140 reach their respective pre-scanning positions, they can be arranged to remain fixed in their respective pre-scanning positions during the remainder of a scanning operation. When the first and second robotic arms 110, 140 reach, and are fixed in their respective pre-scanning positions, the system 100 can be arranged to actuate one or more motors of each of the first and second precision movement devices 120, 150 to translate the x-ray tube 130 and the x-ray detector 160 along one or more precision axes, while capturing images of a first region of interest (ROI) of the asset 170. Again, during translation of the x-ray tube 130 and the x-ray detector 160 along the one or more precision axes, the first and second robotic arms 110, 140 remain fixed in their pre-scanning positions to ensure accuracy of the captured images. Images can be captured by the system 100 by transmitting x-rays from the x-ray tube 130, through the asset 170, which are received by the x-ray detector 160, as illustrated in FIG. 1. Details of the translation of the x-ray tube 130 and the x-ray detector 160 relative to one another along their respective precision axes will be discussed in greater detail below.

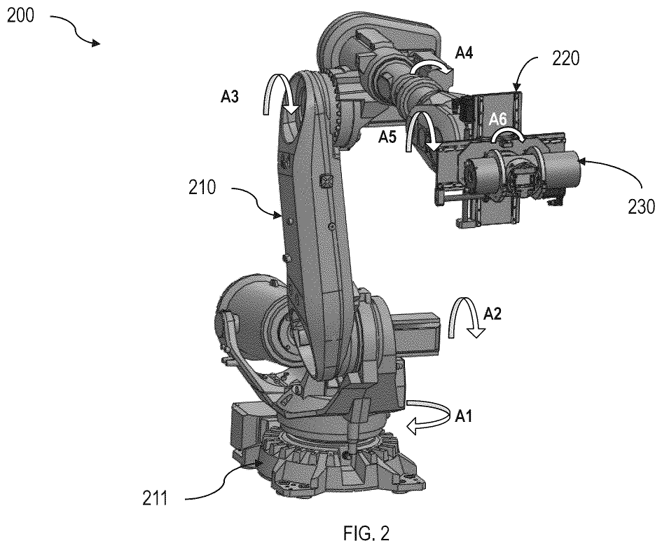

FIG. 2 is a rendering of an exemplary robotic arm system 200 according to the subject matter described herein. In some aspects, the robotic arm system 200 can be similar to the system defined by the first robotic arm 110, the first precision movement device 120 and the x-ray tube 130 of FIG. 1. As shown in FIG. 2, the robotic arm system 200 includes a robotic arm 210, a precision movement device 220 and an x-ray tube 230. In some aspects, the robotic arm can include a base 211 that can be arranged to mount the robotic arm 210 to the ground or to a wall or ceiling of an x-ray shielding room. Additionally, the robotic arm 210 can include a plurality of motorized joints that can provide the robotic arm 210 with a plurality of axes of freedom A1, A2, A3, A4, A5 and A6. In some aspects, the robotic arm 210 can be controlled, either by an operator or autonomously, to move the precision movement device 220 to a pre-scanning position near an asset to be inspected, similarly to as described above.

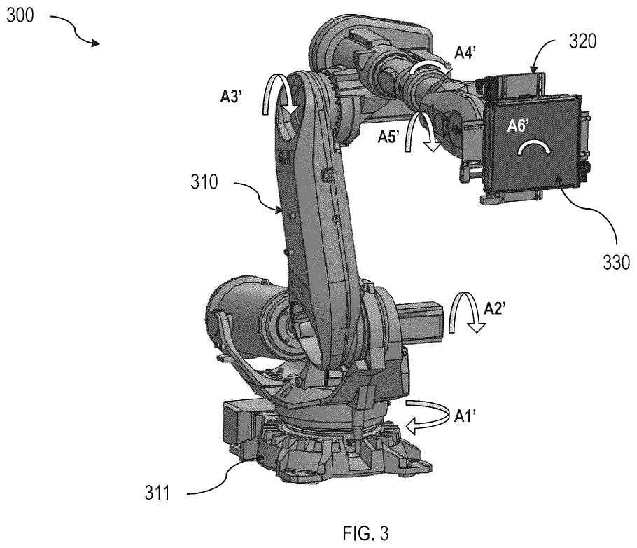

FIG. 3 is a rendering of another exemplary robotic arm system 300 according to the subject matter described herein. In some aspects, the robotic arm system 300 can be similar to the system defined by the second robotic arm 140, the second precision movement device 150 and the x-ray detector 160 of FIG. 1. As shown in FIG. 3, the robotic arm system 300 includes a robotic arm 310, a precision movement device 320 and an x-ray detector 330. In some aspects, the robotic arm can include a base 311 that can be arranged to mount the robotic arm 310 to the ground or to a wall or ceiling of an x-ray shielding room. Additionally, the robotic arm 310 can include a plurality of motorized joints that can provide the robotic arm 310 with a plurality of axes of freedom A1′, A2′, A3′, A4′, A5′ and A6′. In some aspects, the robotic arm 310 can be controlled, either by an operator or autonomously, to move the precision movement device 320 to a pre-scanning position near an asset to be inspected, similarly to as described above.

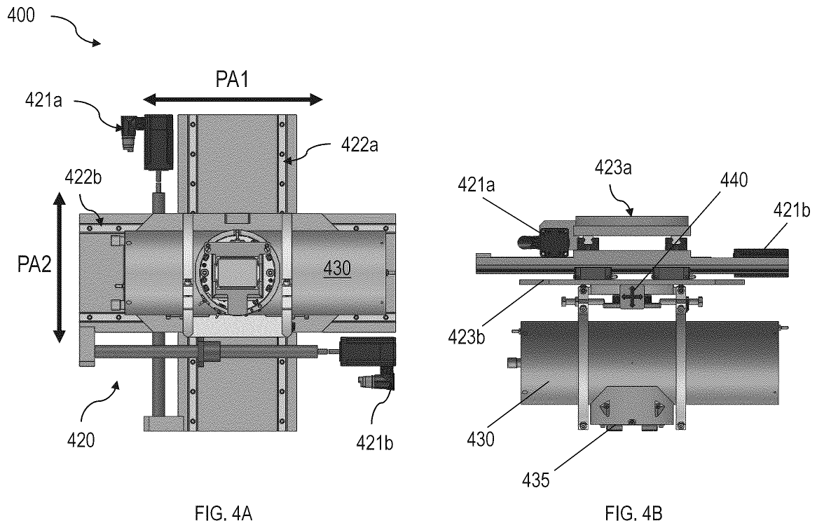

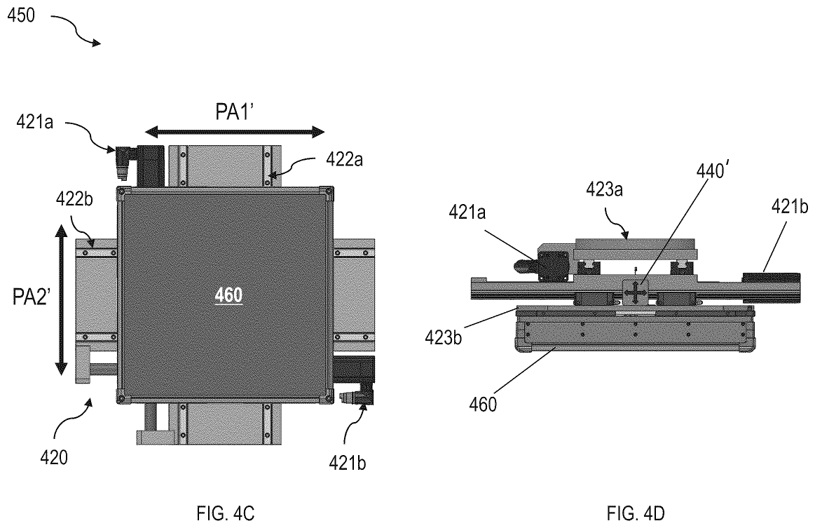

FIGS. 4A-4B are front and top views, respectively, of an exemplary precision movement assembly 400 according to the subject matter described herein. The precision movement assembly 400 can be similar to assemblies defined by the first precision movement device 120 and the x-ray tube 130 of FIG. 1 and the precision movement device 220 and the x-ray tube 230 of FIG. 2. Accordingly, the precision movement assembly 400 includes a precision movement device 420 and an x-ray tube 430.

As shown in FIG. 4A, the precision movement device 420 includes one or more motors 421a, 421b and one or more tracks 422a, 422b that are together arranged to translate the x-ray tube 430 along one or more precision movement axes PA1 and PA2. As shown in FIG. 4B, the precision movement device 420 also includes a first mounting surface 423a and a second mounting surface 423b. The first mounting surface 423a can be used to mount the precision movement assembly 400 to a distal end of a robotic arm (e.g., distal end 110a of the robotic arm 110 of FIG. 1). The second mounting surface can be used to mount the x-ray tube 430 to the precision movement device 420. In some aspects, as shown in FIG. 4B, the precision movement assembly 400 can further include a sensor 440, which can be arranged to measure an angle of tilt of the second mounting surface 423b relative to a vertical direction and/or a position of the precision movement assembly 400 from a surface of an asset being inspected. In some aspects, the sensor 440 can be a tilt/level sensor and/or an optical position sensor (e.g., a laser tracer) or the like. In some cases, the tilt/position sensor 440 can be particularly advantageous for calibration and positioning of the robotic laminography systems describe herein before and during various inspection operations. For example, in reference to FIG. 2, the tilt/position sensor 440 can be arranged to communicate with the controller of the robotic arm 210 to aid in the control of the plurality of motorized joints to move the arm 210 along the A1, A2, A3, A4, A5 and A6 to properly pre-position the precision movement assembly 400 for inspection. In some aspects, the precision movement assembly 400 can further include an additional safety tilt sensor (not shown), which can be used to control the x-ray beam direction inside of the shielding room/cabinet.

During an inspection, once the precision movement assembly 400 is properly pre-positioned, the robotic laminography systems described herein can be arranged to control the one or more motors 421a, 421b to precisely translate the x-ray tube 430 along one or more precision movement axes PA1 and PA2, via the one or more tracks 422a, 422b to one or more precise scanning positions along a scanning path. In some aspects, the scanning path can be a linear path along either of the precision movement axes PA1 and PA2. Additionally, or alternatively, the system can be arranged to control the one or more motors 421a, 421b to precisely translate the x-ray tube 430 along a non-linear scanning path that is defined by a combination of translations along the axis PA1 and the axis PA2. For example, in some aspects, the non-linear scanning path can form a circular/elliptical scanning path (or any other two-dimensional scanning path) defined by combined, precise movements along both of the precision movement axes PA1 and PA2. At each of the one or more precise scanning positions along the scanning path, the robotic laminography systems can be arranged to control the x-ray tube 430 to emit x-ray beams from an emitter 435 of the x-ray tube 430, toward the asset, to be received by a corresponding x-ray detector, as described in greater detail below. In some aspects, the robotic arms and the precision movement assemblies described herein can be controlled by an integrated or remote Programmable Logic Controller (PLC) either autonomously or by an operator. For example, in some aspects, the robotic arms and the precision movement assemblies can be controlled by a remote controller that is either wirelessly or operatively coupled to the system. In some cases, the remote controller can include a joystick or the like, which can allow an operator to intuitively operate the robotic arms and the precision movement assemblies without significant training. Additionally, in some aspects, the precision movement assembly 400 can be designed to translate the second mounting surface 423b and the x-ray tube 430 along the precision movement axes PA1 and PA2 with a precision of less than 20 microns (and in some cases less than 10 microns).

FIGS. 4C-4D are front and top views, respectively, of another exemplary precision movement assembly 450 according to the subject matter described herein. The precision movement assembly 450 can be similar the precision movement assembly 400 of FIGS. 4A-4B, accordingly like components will not be described in detail. Similarly to as described above, and as shown in FIG. 4C, the precision movement assembly 450 includes the precision movement device 420 having one or more motors 421a, 421b and one or more tracks 422a, 422b. However, in the precision movement device 420 of precision movement assembly 450 is arranged to translate an x-ray detector 460 along one or more precision movement axes PA1′ and PA2′. As shown in FIG. 4D, the precision movement device 420 of precision movement assembly 450 also includes the first mounting surface 423a and the second mounting surface 423b. The first mounting surface 423a can be used to mount the precision movement assembly 450 to a distal end of a robotic arm (e.g., distal end 140a of the robotic arm 140 of FIG. 1). The second mounting surface can be used to mount the x-ray detector 460 to the precision movement device 420. In some aspects, as shown in FIG. 4D, the precision movement assembly 450 an further include a sensor 440′, which can be arranged to measure an angle of tilt of the second mounting surface 423b relative to a vertical direction and/or a position of the precision movement assembly 450 from a surface of an asset being inspected. In some aspects, the sensor 440′ can be a tilt/level sensor and/or an optical position sensor (e.g., a laser tracer) or the like, which can be particularly advantageous for calibration and positioning of the robotic laminography systems before and during various inspection operations, similarly to as described above.

During an inspection, once the precision movement assembly 450 is properly pre-positioned, the robotic laminography systems described herein can be arranged to control the one or more motors 421a, 421b to precisely translate the x-ray detector 460 along the one or more precision movement axes PA1′ and PA2′, via the one or more tracks 422a, 422b to one or more precise scanning positions along a scanning path. In some aspects, the scanning path can be a linear path or a non-linear path, similarly to as described above in reference to FIGS. 4A-4B. At each of the one or more precise scanning positions along the scanning path. At each of the one or more precise scanning positions, the x-ray detector 460 can be arranged to receive x-ray beams that are emitted by an emitter of an x-ray tube that is mounted to a corresponding robotic arm on an opposing side of the asset, as shown in FIG. 1. The x-ray beams that are received by the x-ray detector 460 can be used to generate three-dimensional internal and external representations of the asset, as described below. The robotic arms and the precision movement assemblies described in reference to FIGS. 4C-4D can be controlled similarly to as described above in reference to FIGS. 4A-4B.

As shown in at least FIGS. 4A-4D, the precision movement assemblies 400, 450 can have a slim design, which advantageously allows the assemblies 400, 450 to keep their centers of gravity near to tool center points (TCPs) of the respective robotic arms to which they are mounted. Specifically, by having the centers of gravity near to tool center points (TCPs) of the respective robotic arms movements of the robotic laminography systems described herein can be controlled more accurately. Furthermore, this slim design allows for global TCPs of the combined arm and precision movement assemblies to be more easily defined and calibrated, which is essential for precise scanning operations.

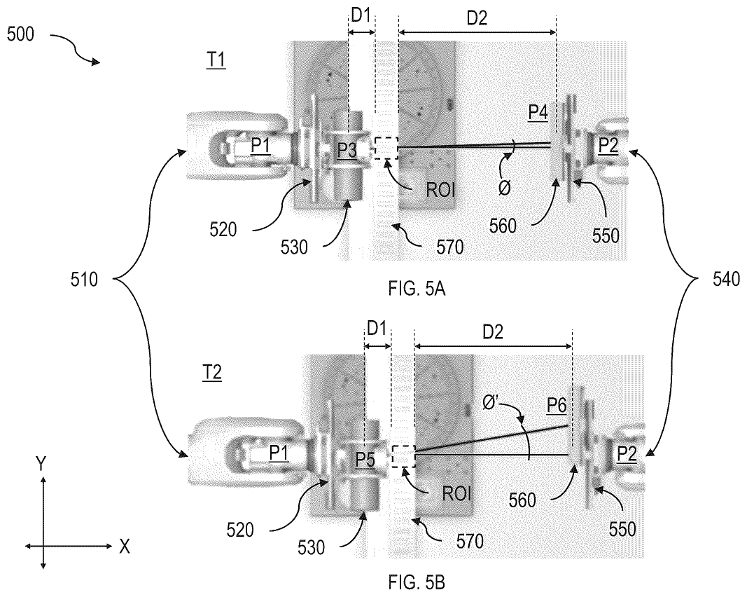

FIGS. 5A-5B illustrate two top views, respectively, of an exemplary robotic laminography system 500 captured at two distinct instances T1, T2, during a scanning operation of an asset 505. In some aspects, the components of the robotic laminography system 500 can be similar to the components of the robotic laminography systems described above in reference to FIGS. 1-4D, accordingly, like components will not be described.

As shown in FIGS. 5A-5B, the system 500 can include a first robotic arm 510 having a first precision movement device 520 coupled to a distal end of the robotic arm 510. The system 500 can also include an x-ray tube 530 that is operatively coupled to the first precision movement device 520. Similarly, the system 500 can include a second robotic arm 540 having a second precision movement device 550 coupled to a distal end of the robotic arm 540. The system 500 can also include an x-ray detector 560 that is operatively coupled to the second precision movement device 550. In some aspects, an asset 570 can be positioned in between the first and second robotic arms 510, 540, as shown in FIGS. 5A-5B. For example, in some cases, the asset 570 can be a large battery or other type of large asset that requires laminographic inspection.

Prior to a scanning operation of a first region of interest (ROI) of the asset 570, the system can be arranged to move the first and second robotic arms 510, 540 into respective pre-scanning positions P1, P2 to prepare for a scanning operation of a first ROI. When the first and second robotic arms 510, 540 are positioned at pre-scanning positions P1, P2, respectively, the x-ray tube 530 and the x-ray detector 560 can be positioned at distances D1, D2, respectively, from opposing surfaces of the asset 570, as shown in FIGS. 5A-5B. In some aspects, the distances D1, D2 can be determined based on the requirements of the inspection. For example, in some aspects, it may be desirable for the x-ray tube 530 to be closer to the asset 570 than the x-ray detector 560, as shown in FIGS. 5A-5B. However, in other inspections, it may be desirable for the x-ray tube 530 and the x-ray detector 560 to be positioned equidistant from the asset 570, or for the x-ray tube 530 to be positioned a greater distance from the asset 570 than the x-ray detector 560.

Once the first and second robotic arms 510, 540 are moved into the pre-scanning positions P1, P2 with the x-ray tube 530 and the x-ray detector 560 positioned at distances D1, D2 from the asset 570, the system 500 can be arranged to fix the robotic arms in the pre-scanning positions P1, P2 and begin a scanning operation of the first ROI. During the scanning operation, the system 500 can be arranged to actuate one or more motors of each of the first and second precision movement devices 520, 550, as described above in reference to FIGS. 4A-4D, to translate the x-ray tube 530 and the x-ray detector 560 along a first scan path and a second scan path, respectively, via the one or more precision axes of each precision movement device, while capturing images of a first region of interest (ROI) of the asset 570. For example, in reference to FIGS. 4A-4D, the scan paths that are traversed by the x-ray tube 530 and the x-ray detector 560 can be defined along the precision axes PA1, PA2 and PA1′, PA2′, respectively. In some aspects, the relative movements of the x-ray tube 530 and the x-ray detector 560 along the first and second scan paths can be proportionate to the distances D1, D2. For example, in a case where the x-ray tube 530 is closer to the asset 570 than the x-ray detector 560, as shown in FIGS. 5A-5B, the first scan path traversed by the x-ray tube 530 can be smaller, relative to the second scan path traversed by the x-ray detector 560. Inversely, in a case where the x-ray tube 530 is further from the asset 570 than the x-ray detector 560, the first scan path traversed by the x-ray tube 530 can be larger, relative to the second scan path traversed by the x-ray detector 560. In a case where the x-ray tube 530 and the x-ray detector 560 are positioned equidistant from the asset 570, the first and second scan paths can be arranged to mirror one another.

As the x-ray tube 530 and the x-ray detector 560 move along their respective first and second scan paths, the x-ray tube 530 can be arranged to emit rays, through the asset 570 at a variety of different angles to be received by the x-ray detector. By moving along the scan paths and changing the angles of x-ray emission, the system is able to acquire a plurality of x-ray images from different angles, which can be compiled into a comprehensive view of the ROI. For example, as shown in FIG. 5A, at time T1, the x-ray tube 530 can be at a position P3 along the first scan path and the x-ray detector 560 can be at a position P4 along the second scan path. In this instance, x-ray tube 530 can be arranged to emit x-ray beams through the asset 570 at an angle Ø relative to horizontal axis (X) through the asset 570. Over the course of the inspection, at time T2, the x-ray tube 530 can be at a position P5 along the first scan path and the x-ray detector 560 can be at a position P6 along the second scan path. In this instance, x-ray tube 530 can be arranged to emit x-ray beams through the asset 570 at an angle Ø′ relative to horizontal axis (X) through the asset 570. The images acquired over the course of the inspection, from a plurality of positions along the first and second scan paths, can be combined to generate a comprehensive scan of the ROI.

Once the system has completed the inspection of the first ROI, the system can be arranged to move the first and second robotic arms 510, 540 into sequential pre-scanning positions to prepare for a scanning operation of a second ROI of the asset 570 which can be executed similarly to as described above. Accordingly, the system 500 can advantageously be arranged to perform inspections of all disparate ROIs across a large asset, without having to move the asset and with significantly improved precision.

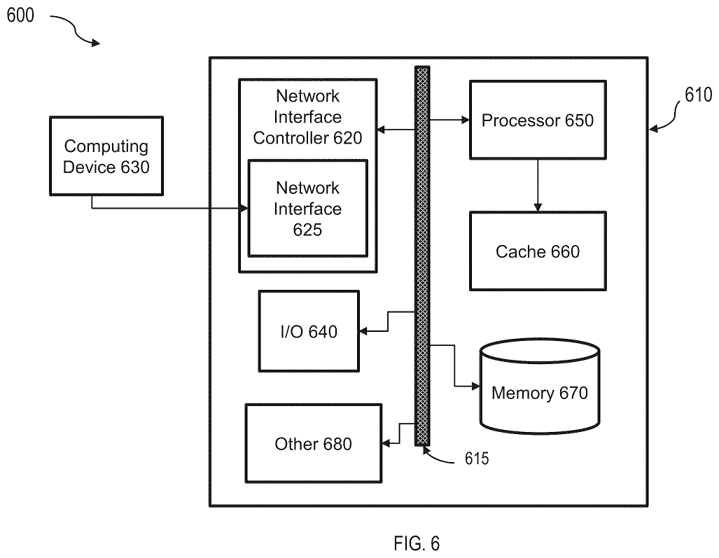

FIG. 6 is a block diagram 600 of a computing system 610 suitable for use in implementing the computerized components described herein. In broad overview, the computing system 610 includes at least one processor 650 for performing actions in accordance with instructions, and one or more memory devices 660 and/or 670 for storing instructions and data. The illustrated example computing system 610 includes one or more processors 650 in communication, via a bus 615, with memory 670 and with at least one network interface controller 620 with a network interface 625 for connecting to external devices 630, e.g., a computing device. The one or more processors 650 are also in communication, via the bus 615, with each other and with any I/O devices at one or more I/O interfaces 640, and any other devices 680. The processor 650 illustrated incorporates, or is directly connected to, cache memory 660. Generally, a processor will execute instructions received from memory. In some embodiments, the computing system 610 can be configured within a cloud computing environment, a virtual or containerized computing environment, and/or a web-based microservices environment.

In more detail, the processor 650 can be any logic circuitry that processes instructions, e.g., instructions fetched from the memory 670 or cache 660. In many embodiments, the processor 650 is an embedded processor, a microprocessor unit or special purpose processor. The computing system 610 can be based on any processor, e.g., suitable digital signal processor (DSP), or set of processors, capable of operating as described herein. In some embodiments, the processor 650 can be a single core or multi-core processor. In some embodiments, the processor 650 can be composed of multiple processors.

The memory 670 can be any device suitable for storing computer readable data. The memory 670 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid state memory), magnetic disks, and magneto optical disks. A computing device 610 can have any number of memory devices 670.

The cache memory 660 is generally a form of high-speed computer memory placed in close proximity to the processor 650 for fast read/write times. In some implementations, the cache memory 660 is part of, or on the same chip as, the processor 650.

The network interface controller 620 manages data exchanges via the network interface 625. The network interface controller 620 handles the physical, media access control, and data link layers of the Open Systems Interconnect (OSI) model for network communication. In some implementations, some of the network interface controller's tasks are handled by the processor 650. In some implementations, the network interface controller 620 is part of the processor 650. In some implementations, a computing device 610 has multiple network interface controllers 620. In some implementations, the network interface 625 is a connection point for a physical network link, e.g., an RJ 45 connector. In some implementations, the network interface controller 620 supports wireless network connections and an interface port 625 is a wireless Bluetooth transceiver. Generally, a computing device 610 exchanges data with other network devices 630, such as computing device 630, via physical or wireless links to a network interface 625. In some implementations, the network interface controller 620 implements a network protocol such as LTE, Bluetooth, or the like.

The other computing devices 630 are connected to the computing device 610 via a network interface port 625. The other computing device 630 can be a peer computing device, a network device, a server, or any other computing device with network functionality. In some embodiments, the computing device 630 can be a network device such as a hub, a bridge, a switch, or a router, connecting the computing device 610 to a data network such as the Internet.

In some uses, the I/O interface 640 supports an input device and/or an output device (not shown). In some uses, the input device and the output device are integrated into the same hardware, e.g., as in a touch screen. In some uses, such as in a server context, there is no I/O interface 640 or the I/O interface 640 is not used. In some uses, additional other components 680 are in communication with the computer system 610, e.g., external devices connected via a universal serial bus (USB).

The other devices 680 can include an I/O interface 640, external serial device ports, and any additional co-processors. For example, a computing system 610 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations, an I/O device is incorporated into the computing system 610, e.g., a touch screen on a tablet device. In some implementations, a computing device 610 includes an additional device 680 such as a co-processor, e.g., a math co-processor that can assist the processor 650 with high precision or complex calculations.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

One skilled in the art will appreciate further features and advantages of the invention based on the above-described embodiments. Accordingly, the present application is not to be limited by what has been particularly shown and described, except as indicted by the appended claims. All publications and references cited herein are expressly incorporated by reference in their entirety.

1. A precision movement device comprising:
a first mounting surface operable to mount the precision movement device to a robotic manipulation unit;
a second mounting surface operable to mount to an x-ray tube or an x-ray detector to the precision movement device; and
one or more motors provided between the first mounting surface and the second mounting surface, wherein the one or more motors are configured to translate the second mounting surface relative to the first mounting surface along first and second precision axes parallel to the second mounting surface while a position of the first mounting surface is fixed.

2. The precision movement device of claim 1, wherein the one or more motors are configured to translate the second mounting surface along the first and second precision axes with a precision of less than 20 microns.

3. The precision movement device of claim 2, further comprising the robotic manipulation unit, wherein the robotic manipulation unit is a robotic arm that includes a plurality of motorized joints configured to control translational and rotational movement of the precision movement device variously along and about a plurality of pre-positioning axes to a pre-scanning position near an asset prior to performing an inspection of the asset.

4. The precision movement device of claim 3, wherein the one or more motors are configured to translate the x-ray tube or x-ray detector variously along the first and second precision axes along a precise scanning path during the inspection when the robotic manipulation unit is fixed in the pre-scanning position.

5. The precision movement device of claim 4, further comprising a position sensor operatively coupled to the precision movement device and configured to measure a position and a tilt angle of the x-ray tube or x-ray detector.

6. The precision movement device of claim 5, further comprising a controller configured to control movement of the precision movement device and the robotic arm, wherein the controller is configured to perform operations comprising:
receiving position data characterizing the position and tilt angle of the x-ray tube or x-ray detector from the position sensor;
controlling the robotic arm to place the precision movement device in the pre-scanning position; and
controlling the one or more motors of the precision movement device to translate the x-ray tube or x-ray detector along the precise scanning path during the inspection.

7. The precision movement device of claim 3, wherein the robotic arm is mounted to any of a ground, a wall, or a ceiling of an x-ray shielding room.

8. A method comprising:
controlling a first robotic arm to place an x-ray tube in a first pre-scanning position proximate a region of interest (ROI) of an asset to be inspected, wherein the x-ray tube is coupled to the first robotic arm by a first precise movement device;
controlling a second robotic arm to place an x-ray detector in a second pre-scanning position opposite the first pre-scanning position such that the ROI is between the x-ray tube and the x-ray detector, wherein the x-ray detector is coupled to the second robotic arm by a second precise movement device;
controlling the first precision movement device to move the x-ray tube along a first precise path proximate the ROI while emitting x-rays through the asset and while the first robotic arm remains fixed in the first pre-scanning position; and
controlling the second precision movement device to move the x-ray detector along a second precise path proximate the ROI while receiving the x-rays emitted through the asset by the x-ray tube and while the second robotic arm remains fixed in the second pre-scanning position.

9. The method of claim 8, wherein the first and second precision movement devices are configured to move the x-ray tube and detector along the first and second precise paths, respectively, a precision of less than 20 microns.

10. The method of claim 8, wherein the first pre-scanning position is a first distance from a surface of the asset than the second pre-scanning position is a second distance from the surface of the asset, and wherein movement of the x-ray tube and detector along the first and second precise paths, respectively, is proportionate to the first and second distances.

11. The method of claim 10, wherein the first distance is less than the second distance and movement of the x-ray tube along the first precise path is less than movement of the x-ray detector along the second precise path.

12. The method of claim 8, further comprising:
controlling the x-ray tube to emit x-rays through the asset at a plurality of angles as the x-ray tube is moved along the first precise path;
acquiring a plurality of x-ray images of the ROI from the x-ray detector; and
generating a comprehensive view of the ROI based on the plurality of x-ray images.

13. The method of claim 12, further comprising:
controlling the first robotic arm to move the x-ray tube to a third pre-scanning position proximate a next ROI of the asset;
controlling the second robotic arm to move the x-ray detector to a fourth pre-scanning position opposite the third pre-scanning position such that the next ROI is between the x-ray tube and the x-ray detector;
controlling the first precision movement device to move the x-ray tube along a third precise path proximate the ROI while emitting x-rays through the asset and while the first robotic arm remains fixed in the third pre-scanning position;
controlling the second precision movement device to move the x-ray detector along a fourth precise path proximate the ROI while receiving the x-rays emitted through the asset by the x-ray tube and while the second robotic arm remains fixed in the fourth pre-scanning position;
acquiring a next plurality of x-ray images of the next ROI from the x-ray detector; and
generating a comprehensive view of the asset by combining the comprehensive view of the ROI and a comprehensive view of the next ROI.

14. The method of claim 8, wherein the first and second precise paths are non-linear two-dimensional scanning paths.

15. A system comprising:
a first robotic arm controllable to move an x-ray tube to a first pre-scanning position proximate a region of interest (ROI) of an asset to be inspected;
a first precision end effector provided between the first robotic arm and the x-ray tube and controllable to move the x-ray tube along a first precise scanning path proximate the ROI during an inspection while the first robotic arm remains fixed in the first pre-scanning position
a second robotic arm controllable to move an x-ray detector to a second pre-scanning position proximate the ROI and opposite the x-ray tube; and
a second precision end effector provided between the second robotic arm and the x-ray detector and controllable to move the x-ray detector along a second precise scanning path proximate the ROI during the inspection while the second robotic arm remains fixed in the second pre-scanning position.

16. The system of claim 15, wherein the first and second precision end effectors are configured to move the x-ray tube and the x-ray detector relative to the first and second robotic arms, respectively, with a precision of less than 20 microns.

17. The system of claim 15, wherein the first and second robotic arms are mounted to any of a ground, a wall, or a ceiling of an x-ray shielding room.

18. The system of claim 15, further comprising a controller configured to control the first precision end effector to translate the x-ray tube along the first precise scanning path and the second precision end effector to translate the x-ray detector along the second precise scanning path to perform an inspection of the ROI.

19. The system of claim 18, wherein the first precision end effector includes a first position sensor configured to measure a position and a tilt angle of the x-ray tube and the second precision end effector includes a second position sensor configured to measure a position and a tilt angle of the x-ray detector.

20. The system of claim 19, wherein the controller is further configured to:
receive, from the first and second position sensors, position data characterizing the position and tilt angle of the x-ray tube in the first pre-scanning position and the x-ray detector in the second pre-scanning position; and
control the first and second precision end effectors to translate the x-ray tube and x-ray detector along the first and second precise scanning paths, respectively, responsive to determining that x-ray tube in the first pre-scanning position is properly aligned with the x-ray detector in the second pre-scanning position.
